(19) United States
(12) Patent Application Publication
(10) Pub. No.: US 2012/0251024 A1
(43) Pub. Date: Oct. 4, 2012

(54) Ball Bearing and Corresponding Bump Stop

(75) Inventors: Sebastien Brisson, Contamine sur Arve (FR); Antony Chamousset, Salles (FR)

(73) Assignee: NTN-SNR ROULEMENTS, Annecy (FR)

(21) Appl. No.: 13/501,851

(22) PCT Filed: Oct. 14, 2010
(86) PCT No.: PCT/FR2010/000685

§ 371 Date: Jun. 19, 2012

(30) Foreign Application Priority Data
Oct. 16, 2009 (FR) 0904977

(51) Int. Cl. F16C 19/04

(52) U.S. Cl. 384/513

(57) ABSTRACT

A bearing for an angularly contacting bump stop, the washers of which consist of stamped sheet metal and have a surrounding geometry. The geometry of the bearing is such that, in every cutaway containing the geometrical axis of rotation of the bearing, the lower raceway forms a lower circle arc which defines a lower axial curvature center, the upper raceway forms an upper circle arc which defines an upper axial curvature center, the upper and lower curvature centers being located on an angular geometrical axis that forms with the geometrical axis of rotation an angle of obliquity of a value between 5° and 65°. Specifically, the lower circle arc has two ends defining an opening angle of a value greater than or equal to 80° and a tangent located in a lower plane perpendicular to the axis of rotation at a lower tangent point defining with the end of the nearest lower circle arc a portion of the lower circle arc having an opening angle greater than or equal to 10°.

### BACKGROUND

1. Technical Field of the Invention

The invention relates to a vehicle bump stop, provided with a ball bearing.

2. Prior Art

The use of a bearing with washers made from stamped sheet metal in bump stops is presented for example by document FR2918138. In such a stop, one of the washers materialising the raceways, referred to as the lower washer, is pressing against a plastic support constituting an interface with a helical suspension spring of the wheel, the other washer, referred to as the upper washer, pressing under a cover fixed to the body of the vehicle. The raceways have as a section a profile in the form of a circle arc of which the opening angle is 60°. The raceway of the lower washer is open radially towards the interior and does not comprise any edge that can radially limit the movement of the balls towards the interior. This results from the fact that the circle arc of the raceway of the lower washer is not at any point tangent to a plane perpendicular to the axis of rotational symmetry of the raceway. In an analogous manner, the raceway of the upper washer is radially open towards the exterior and does not comprise any edge that can radially limit the movement of the balls towards the exterior, which results geometrically by the fact that the circle arc of the raceway of the upper washer is not at any point tangent to a plane perpendicular to the axis of rotational symmetry of the upper raceway. Yet the solicitations of such a stop are multidirectional and dissymmetrical, which results in constraints that are highly unequally distributed between the balls. If the stop is undersized in relation to these solicitations, an opening of the bearing and radial movements of the balls can then be observed which can in the extreme result in the expulsion of a ball. The potential malfunction of the bearing can also be manifested via a stick-slip motion of the balls with sudden losses of adherence interrupting the bearing of certain balls on the raceways and causing sliding generating rapid wear. Moreover, the plastic parts that comprise the spring support and the cover, if they are undersized, can also undergo deformations and come into contact with each other, which accentuates the malfunction of the stop.

### SUMMARY OF THE INVENTION

The invention aims to overcome the disadvantages of prior art and in particular to propose a bearing having a reinforced rigidity as well as a better resistance to radial forces.

According to a first aspect of the invention, the latter relates to a bearing according to the invention of the general type, comprising: a lower washer forming a lower raceway, an upper washer having an upper raceway, and balls rolling on the lower and upper raceways in order to provide for the relative rotation of the upper and lower washers around a geometrical axis of rotation of the bearing.

Here as in all of the text of the application, the expressions “lower washer” and “upper washer” are used in reference to a preferred use of the bearing according to the invention, i.e. within a vehicle bump stop, wherein the axis of rotation of the bearing is close to the vertical and the upper washer is arranged axially above the lower washer. However, outside of this context, the terms “upper” and “lower” are to be understood as an arbitrary designation of the washers.

The bearing according to the invention is more specifically of the angular contact type, which, in the framework of this application, means that the geometry of the bearing is such that in every cutaway containing the geometrical axis of rotation of the bearing, the lower raceway forms a lower circle arc which defines a lower axial curvature centre, the upper raceway forms an upper circle arc which defines an upper axial curvature centre, the lower and upper curvature centres being located on an angular geometrical axis forming with the geometrical axis of rotation an angle of obliquity of a value between 5° and 65°, and more preferably between 20° and 50°. According to a particular embodiment corresponding to the sizing of a particular bump stop, the angle of obliquity is of a magnitude of 35°.

According to the invention, the geometry of the lower raceway is characterised in that in every cutaway containing the geometrical axis of rotation of the bearing, the lower circle arc has two ends defining an opening angle of a value greater than or equal to 80° and a tangent located in a lower plane perpendicular to the axis of rotation at a lower tangent point defining with the end of the nearest lower circle arc a portion of the lower circle arc having an opening angle greater than or equal to 10°.

The lower raceway is therefore particularly surrounding, which makes it possible to radially confine the balls. The lower circle arc extending on either side of the lower tangent point, the raceway can take up centrifuge and centripetal radial forces.

In the preceding definition, the bearing is considered as out of load, as the axis of rotation of the bearing is confounded with the axis of rotational symmetry of the lower raceway and with the axis of rotational symmetry of the upper raceway.

The raceways are the surfaces of the upper and lower washers intended to be in contact with the balls, and can where applicable receive a treatment intended to increase their hardness, for example a heat treatment. In a known manner, they also receive more preferably a surface treatment for protecting against corrosion and rectification or superfinishing aimed at reducing their roughness.

Preferentially, the geometry of the upper raceway is characterised in that in every cutaway containing the geometrical axis of rotation of the bearing, the upper circle arc has two ends defining an opening angle of a value greater than or equal to 80° and a tangent located in an upper plane perpendicular to the axis of rotation at an upper tangent point defining with the end of the nearest upper circle arc a portion of the upper circle arc having an opening angle greater than or equal to 10°.

As such, the upper raceway is also particularly surrounding, which makes it possible to radially confine the balls between the two washers.

According to a preferred embodiment, the lower washer is comprised of sheet metal, for example stamped sheet metal. The lower raceway constitutes a deep groove, but compatible with the stamping.

In this embodiment made of sheet metal, the lower washer can be provided with a stiffening cylindrical lower skirt.

Similarly, the upper washer can also be comprised of sheet metal, for example stamped sheet metal and can also be provided with a stiffening cylindrical upper skirt.

The invention furthermore relates to a bump stop comprising a thrust bearing such as described previously, a lower supporting means to transmit to the lower washer of the bearing the forces exerted by a suspension spring and a cover to transmit to the body of the vehicle the forces exerted by the spring and passing through the thrust bearing.

Such an assembly makes it possible to avoid the problem of swiveling of the bearing and simultaneously the deformations of the upper and lower supporting means. The stop has a reduced radial clearance. The axial compactness of the whole is excellent.

As such this invention, by stiffening the bearing and the interface of the latter with the supporting means, prevents the latter from moving in relation to one another and/or from deforming; the clearances between the supporting means are as such controlled, in particular on baffles between the upper and lower supporting means, improving as such the sealing.

In particular, the architecture of the stop is compatible with lower and/or upper supporting means made from plastic material, where applicable without metal insert.

According to a particular embodiment, the angle of obliquity is open towards the lower supporting means. This arrangement, which corresponds to most vehicles, allows for a centring of the stop inside the cover.

According to a particular advantageous embodiment, the lower washer comprises a stiffening cylindrical lower skirt forming a lower cylindrical bearing pressing radially against the lower supporting means. The lower skirt contributes to the stiffening of the washer itself and to that of the sub-unit constituted with the lower supporting means.

Similarly, the upper washer can comprise a stiffening cylindrical upper skirt forming an upper cylindrical bearing pressing radially against the cover. According to a preferred embodiment, the cylindrical upper skirt protrudes axially towards the lower supporting means and is preferentially at least partially opposite and at a distance from the lower cylindrical skirt. The objective here is to reduce the opening between the washers, between the upper skirt and the lower washer, in such a way as to create a loss of load or a labyrinth that opposes the entry of pollutants in the bearing.

### BRIEF DESCRIPTION OF THE DRAWINGS

Other characteristics, details and advantages of the invention shall appear when reading the following description, in reference to the annexed figures, which show:

FIG. 1, a bump stop according to an embodiment of the invention;

FIG. 2, a cross-section view of a bearing of the stop of FIG. 1.

For increased clarity, identical or similar elements are marked with identical reference signs on all of the figures.

### DETAILED DESCRIPTION OF THE PREFERRED EMBODIMENT(S)

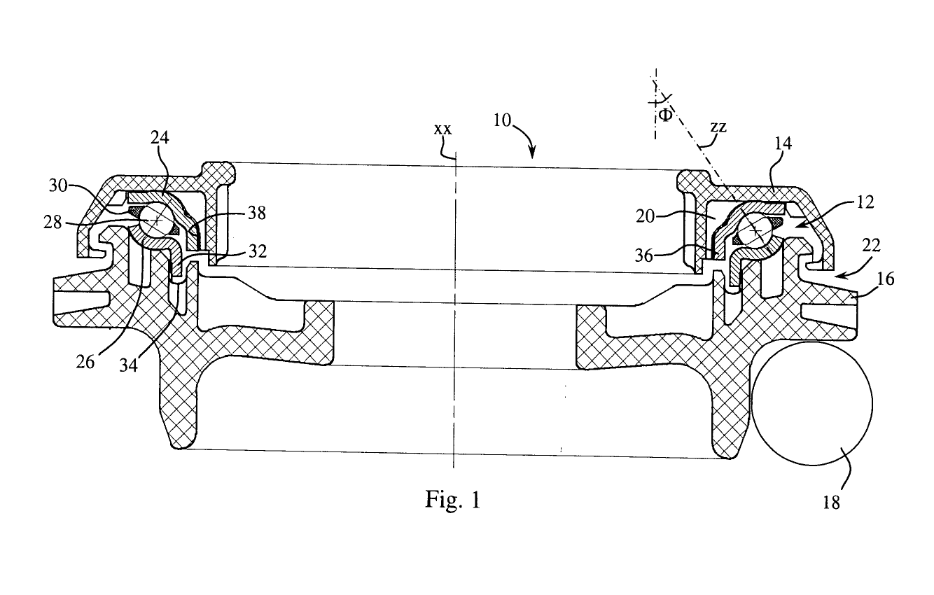

FIG. 1 shows a bump stop 10 comprising a ball bearing inserted between a cover 14 constituting an interface with the body of the vehicle and a lower supporting part 16 intended to come to rest, directly or with interposition of a rubber dampening ring, on the upper spire of a helical suspension spring 18. The cover 14 and the lower supporting part 16 are made from plastic materials. Their forms define an annular housing 20 for the bearing 12, which opens onto the exterior via a baffle 22.

The bearing 12 is comprised of an upper washer 24 fixed to the cover 14, of a lower washer 26 pressing against the lower supporting part 16, the washers defining between them an annular volume wherein are housed balls 28 retained where applicable by a cage 30.

Each of the washers 24, 26 is comprised of sheet metal, formed more preferably by stamping.

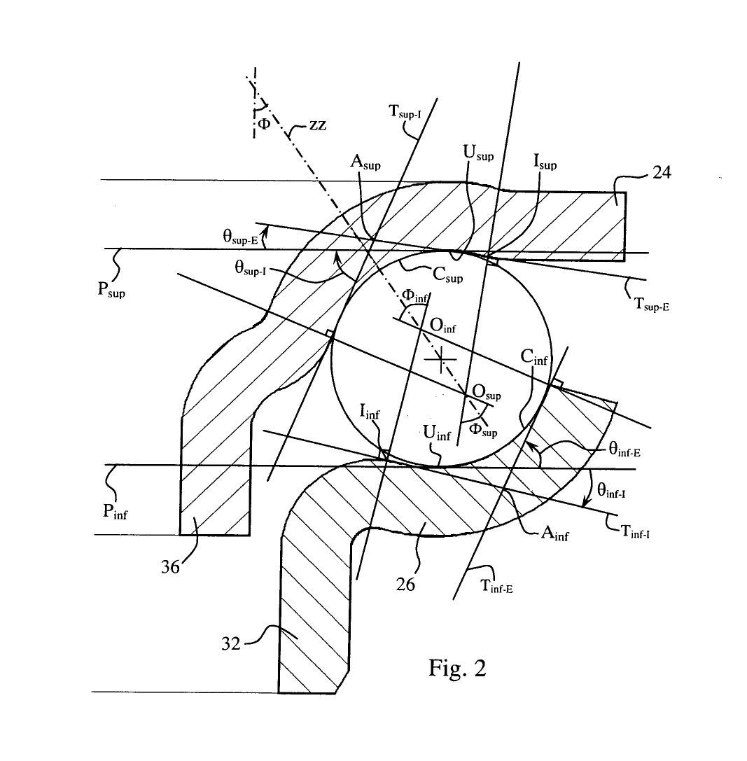

On the lower washer 26 is defined a lower raceway, which in a known manner is a surface of revolution of which the generating line is, in the cutaway of FIGS. 1 and 2, a circle arc C_{Inf} with a radius that is greater than the radius of the balls. Likewise is defined on the upper washer 24 an upper raceway constituting a surface of revolution of which the generating line is a circle arc C_{Sup} of a radius that is greater than the radius of the balls. After assembly, and when the bearing is at rest, the axis of rotational symmetry of the lower washer, the axis of rotational symmetry of the upper washer and the axis of rotation of the bearing (XX) are intended to be confounded. In the geometrical considerations which shall follow, it is assumed that this condition is fulfilled.

As the bearing 12 is of the angular contact type, the curvature centres O_{Sup} and O_{Inf} of the two circle arcs of the upper raceway and of the lower raceway are located, in an axial cutaway, on an angular axis (ZZ) in relation to the axis of rotation of the bearing. Through rotational symmetry, the curvature centres O_{Sup} and O_{Inf} are also located on a cone of which the cone distance is the preceding angular axis, this cone also containing the centres of the balls and the pitch circle defined by the centres of the balls. In the example embodiment, the angular axis forms with the axis of rotation of the bearing an angle Φ opening towards the bottom of 35°, which is the half-angle of the opening of the cone mentioned previously.

Remarkably, the circle arc C_{Inf} of the lower raceway has a substantial opening angle φ_{Inf}, of at least 80°. This allows for a substantial surrounding of the balls. The interior radial end of the circle arc C_{Inf} constitutes a point of inflection I_{Inf} of the profile of the interior surface of the lower washer 26.

Also remarkably, it is possible to trace a tangent to the circle arc C_{Inf} which is perpendicular to the axis of rotational symmetry of the washer. The plane perpendicular to the axis of rotational symmetry of the washer and containing this tangent shall be denoted in what follows as P_{Inf}. The point of intersection between the plane P_{Inf} and the arc C_{Inf} shall be denoted as U_{Inf}.

If the tangent T_{Inf}_{_{—}}_{E} is traced to the circle arc of the lower raceway located at the exterior radial end of the washer, it is observed that this tangent forms a substantial positive angle θ_{Inf}_{_{—}}_{E} with the reference plane P_{Inf}. At the other end of the circle arc of the lower raceway, on the radially internal side in relation to the axis of rotation, the tangent T_{Inf}_{_{—}}_{I} to the circle arc is oriented by a low negative angle θ_{Inf}_{_{—}}_{I} in relation to reference plane P_{Inf}. The angle θ_{Inf}_{_{—}}_{I} is also the measurement of the portion of the arc C_{Inf} between the points I_{Inf} and U_{Inf}. By construction, the angles defined as such establish:

φ_{Inf}=θ_{Inf}_{_{—}}_{E}−θ_{Inf}_{_{—}}_{I}

Also remarkably, the two tangents T_{Inf}_{_{—}}_{E} and T_{Inf}_{_{—}}_{I} are secant at a point A_{Inf} located on the side of the plane P_{Inf} opposite the circle arc C_{Inf} of the lower raceway.

In order to provide an optimal surrounding of the balls, the angles θ_{Inf}_{_{—}}_{I} and θ_{Inf}_{_{—}}_{E} must be, in absolute value, as large as possible, and establish the following inequalities:

θ_{Inf}_{_{—}}_{I}<−10°

θ_{Inf}_{_{—}}_{E}>+60°

φ_{Inf}=θ_{Inf}_{_{—}}_{E}−θ_{Inf}_{_{—}}_{I}≧80°

The washer 26 is extended radially downwards by a cylindrical skirt 32. As can be seen in FIG. 1, this cylindrical skirt 32 is radially pressing against a cylindrical seating 34 of the lower supporting part 16. The cylindrical skirt 32 increases the moment of inertia of the lower washer 26 and contributes to its stiffening, in particular in the deformation modes as twisting and bending. Moreover, the cylindrical skirt 32 contributes to the stiffening of the sub-unit constituted by the lower washer 26 and by the lower supporting part 16.

The specific profile of the upper raceway can be described by similar geometrical considerations.

As for the lower washer, the circle arc of the raceway of the upper washer 24 has a substantial opening angle φ_{Sup}, of at least 80°. This allows for a substantial surrounding of the balls 28. The exterior radial end of the circle arc C_{Sup} constitutes a point of inflection I_{Sup} of the profile of the interior surface of the upper washer 24.

Also remarkably, it is possible to trace a tangent to the circle arc C_{Sup} which is perpendicular to the axis of rotational symmetry of the upper washer 24. The plane perpendicular to the axis of rotational symmetry of the upper washer 24 and containing this tangent shall be denoted in what follows as P_{Sup}. The point of intersection between the plane P_{Sup} and the arc C_{Sup} shall be denoted as U_{Sup}.

If the tangent T_{Sup}_{_{—}}_{E} to the circle arc C_{Sup} of the upper raceway located at the exterior radial end of the washer is traced, it is observed that this tangent forms an angle θ_{Sup}_{_{—}}_{E} with the reference plane P_{Sup}. At the other end of the circle arc of the upper raceway, on the radially internal side in relation to the axis of rotation, the tangent T_{Sup} _{_{—}}_{I} to the circle arc is oriented by an angle θ_{Sup}_{_{—}}_{I} in relation to the reference plane P_{Sup}. The angle θ_{Sup}_{_{—}}_{I} is also the measurement of the portion of the arc C_{Sup} between points I_{Sup} and U_{Sup}. By construction, the angles defined as such establish:

φ_{Sup}=θ_{Sup}_{_{—}}_{I}−θ_{Sup}_{_{—}}_{E}

Also remarkably, the two tangents T_{Sup}_{_{—}}_{E} and T_{Sup}_{_{—}}_{I} are secant at a point A_{Sup} located on the side of the plane P_{Sup} opposite the circle arc C_{Sup} of the upper raceway.

In order to provide an optimal surrounding of the balls, the angles θ_{Sup}_{_{—}}_{I} and θ_{Sup}_{_{—}}_{E} must be, in absolute value, as large as possible. In practice, angles can be obtained via stamping that establish:

θ_{Sup}_{_{—}}_{E}<−10°

θ_{Sup}_{_{—}}_{I}>+60°

φ_{Sup}=θ_{Sup}_{_{—}}_{I}−θ_{Sup}_{_{—}}_{E}≧80°

The interior radial end of the circle arc C_{Sup} constitutes a point of inflection of the profile of the interior surface of the lower washer. The upper washer 24 is radially extended downwards by a cylindrical skirt 36. As can be seen in FIG. 1, this cylindrical skirt 36 is radially pressing against a cylindrical seating 38 of the cover 12. The cylindrical skirt 36 increases the moment of inertia of the upper washer 24 and contributes to its stiffening, in particular in the deformation modes as twisting and bending. Moreover, the cylindrical skirt 36 contributes to the stiffening of the sub-unit constituted by the upper washer 26 and by the cover 14. Moreover, the two cylindrical skirts 32, 36 delimit a narrow annular passage constituting a loss of load.

In order for the surrounding raceways to provide their function of guiding in an optimal manner, it is interesting that each point of the lower circle arc C_{Inf} has an image on the upper circle arc, i.e. a symmetrical point through a central symmetry including the centre of a ball. In practice, this condition is fulfilled if the straight lines T_{Sup}_{_{—}}_{E} and T_{Inf}_{_{—}}_{I} are parallel or form an angle less than 10°, and if similarly, the straight lines T_{Sup}_{_{—}}_{I} and T_{Inf}_{_{—}}_{E} are parallel or form an angle less than 10°.

Naturally, diverse variations in form or in material are possible, without leaving the scope defined by the claims.

1-13. (canceled)

14. Bearing comprising
a lower washer forming a lower raceway,
an upper washer forming an upper raceway,
balls rolling on the lower and upper raceways in order to provide relative rotation of the upper and lower washers around a geometrical axis of rotation of the bearing,
the bearing having a geometry such that in every cutaway containing the geometrical axis of rotation of the bearing, the lower raceway forms a lower circle arc which defines a lower axial curvature center, the upper raceway forms an upper circle arc which defines an upper axial curvature center, the lower and upper axial curvature centers being located on an angular geometrical axis forming with the geometrical axis of rotation an angle of obliquity of a value between 5° and 65°, and in every cutaway containing the geometrical axis of rotation of the bearing, the lower circle arc has two ends defining an opening angle of a value greater than or equal to 80° and a tangent located in a lower plane perpendicular to the geometrical axis of rotation at a lower tangent point defining with an end of the nearest lower circle arc a portion of the lower circle arc having an opening angle greater than or equal to 10°.

15. Bearing according to claim 1, wherein every cutaway containing the geometrical axis of rotation of the bearing, the upper circle arc has two ends defining an opening angle of a value greater than or equal to 80° and a tangent located in an upper plane perpendicular to the geometrical axis of rotation at an upper tangent point defining with an end of the nearest upper circle arc a portion of the upper circle arc having an opening angle greater than or equal to 10°.

16. Bearing as claimed in claim 14, wherein the lower washer is comprised of sheet metal.

17. Bearing as claimed in claim 16, wherein the sheet metal is a stamped sheet metal.

18. Bearing according to claim 16, wherein the lower washer is provided with a stiffening cylindrical lower skirt.

19. Bearing as claimed in claim 14, wherein the upper washer is comprised of sheet metal.

20. Bearing as claimed in claim 19, wherein said sheet metal is a stamped sheet metal.

21. Bearing according to claim 19, wherein the upper washer is provided with a stiffening cylindrical upper skirt.

22. Bump stop intended to be inserted between a suspension spring and a body of a vehicle, the bump stop comprising:
a bearing as claimed in claim 14,
a lower supporting means for transmitting to the lower washer of the bearing of the forces exerted by a suspension spring, and
a cover for transmitting to the body of the vehicle the forces exerted by the suspension spring and passing through the bearing.

23. Stop according to claim 22, wherein the cover and the lower supporting means are made of a plastic material.

24. Stop according to claim 22, wherein the angle of obliquity is open towards the lower supporting means.

25. Stop according to claim 22, wherein the lower washer comprises a stiffening cylindrical lower skirt radially pressing against the lower supporting means.

26. Stop according to claim 25, wherein the upper washer comprises a stiffening cylindrical upper skirt radially pressing against the cover.

27. Stop according to claim 26, wherein the cylindrical upper skirt protrudes axially towards the lower supporting means.

28. Stop according to claim 27, wherein the cylindrical upper skirt is at least partially opposite and at a distance from the lower cylindrical skirt.
